(19) United States
(12) Patent Application Publication
(10) Pub. No.: US 2007/0029798 A1
(43) Pub. Date: Feb. 8, 2007

(54) AN END FITTING FOR PIPING SYSTEMS

(76) Inventor: Craig S. ADORNI, Twinsburg, OH (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/425,053

(22) Filed: Jun. 19, 2006

Related U.S. Application Data
(60) Provisional application No. 60/691,926, filed on Jun. 17, 2005.

(51) Int. Cl. F16L 15/00

(52) U.S. Cl. 285/901; 285/390

(57) ABSTRACT

An end fitting for a piping system requires no tools for tightening or seal agents for sealing. The end fitting includes a sealing body adopted to receive a pipe member, which includes an externally threaded portion. The sealing body includes an internally threaded section, which is shorter than the externally threaded portion of the pipe member. A seal retainer is placed in an annular groove made in the sealing body. The seal retainer is adopted to contact the externally threaded portion of the pipe member prior. After the contact takes place, the oppositely threaded portions of the sealing body and the pipe member are engaged.

### CROSS-REFERENCE TO RELATED APPLICATIONS

This application is based on and claims priority to provisional U.S. patent application Ser. No. 60/691,926, which was filed on Jun. 17, 2005.

### BACKGROUND OF THE INVENTION

This invention is directed to piping systems used in new and existing construction. More particularly, the present invention is directed to an end fitting for a piping system that provides a fitting cap for use in various plumbing and piping situations utilizing threaded pipes.

The current state of art requires pipe system assemblers to run utility, waste, and vent pipe lines in the rough-in infrastructure of buildings, pipe ends being located at desired delivery points. Prior to finish construction of encapsulating surroundings such as walls, foundation pads, and the like, the piping system used, such as gas, water, and air lines, are pressure tested for pipe line integrity. Testing requires the assembler to cap off ends at all delivery points with a pressure tight seal to allow pressure testing to be accomplished prior to finishing structures. Thus, pressure tight seals, although temporary, are required for gas and water inlets, and the like, that assure the pipe line code approval.

Current national pipe thread forms are designed for a rigid joint. However, sealing solutions are still used to augment the pressure tight seal of the mechanical joint. A drawback in prior art sealing solutions for standard national pipe thread forms is a necessity to utilize Teflon tape and plumber putty to the male or female pipe fittings, which is time consuming. In addition, the use of plumber putty might lead to importing contaminants inside the tubing. Another disadvantage of prior art piping pressure tight seals, is that the taper threads of the fittings are designed to force engage into each other (male threads into female threads) requiring two pipe wrenches to secure the assembly. After the construction is finalized, pipe end caps are removed, and sealing solutions, such as tape and putty, have to be cleaned off pipe ends. Then water and gas utilities are provided with permanent fittings.

Thus, there is a need for a temporary end fitting piping system allowing for finalizing construction or encapsulating structures prior to assembling a permanent piping connection that overcomes above described drawbacks. There is a need for an end fitting for a piping system that does not require the use of sealing agents. There is also a need for an end fitting for a piping system that requires less effort for installation, and be suited for assembling by hand tightening without the use of tools. There is also a need for a temporary end fitting piping system that provides a clean environment inside the tubing.

### SUMMARY OF INVENTION

In accordance with the present invention, there is provided an end fitting piping system.

Further, in accordance with the present invention, there is provided an end fitting piping system allowing for finalizing construction or encapsulating structures prior to assembling a permanent piping connection that overcomes above described drawbacks.

Still further, in accordance with the present invention, there is provided an end fitting for a piping system that does not require the use of sealing agents.

Still further, in accordance with the present invention, there is provided an end fitting for a piping system that requires less effort for installation, and is suited for assembling by hand tightening without the use of tools.

Still further, in accordance with the present invention, there is provided a temporary end fitting piping system that makes available a clean environment inside the tubing.

Further, in accordance with the present invention, the end fitting for a piping system includes a sealing body, which further includes an end cap portion, and a hollow portion. The end cap portion at least partially overlaps the hollow portion. The hollow portion of the sealing body includes at least one seal retainer. The hollow portion of the sealing body is adapted to receive an externally threaded portion of a pipe member, which externally threaded portion has a distal part. The hollow portion of the sealing body includes an internally threaded section and a threadless section. The threads in the internally threaded section of the hollow portion of the sealing body are tapered oppositely to the threads in an externally threaded portion of a pipe member. The internally threaded section of the hollow portion of the sealing body is adapted to engage an externally threaded portion of a pipe member. The at least one seal retainer is adapted to come in contact with a distal part of an externally threaded portion of a pipe member prior to the internally threaded section of the hollow portion of the sealing body engaging an externally threaded portion of a pipe member.

In a preferred embodiment, the threadless section of the hollow portion of the sealing body further includes at least one annular groove located adjacent to the internally threaded section of the hollow portion of the sealing body. The at least one seal retainer is placed in the at least one annular groove. The diameter of the at least one annular groove is to some extent smaller than the diameter of the at least one seal retainer. The cross section of the at least one seal retainer is one of round, square, and rectangular. Preferably, the length of the internally threaded section of the hollow portion of the sealing body is substantially less than the length of externally threaded portion of the pipe member.

In another preferred embodiment, the internally threaded section of the hollow portion of the sealing body is adapted to American standard taper pipe thread sizes. Typically, the range of American standard taper pipe thread sizes is from 1/16 to 4 inches in their approximate increments of 1/16, ⅛, 1/4, and ½.

According to another preferred embodiment, the sealing body and the pipe member are hand tightened up. The at least one seal retainer is, preferably, made of a resilient material.

Still other objects and aspects of the present invention will become readily apparent to those skilled in this art from the following description wherein there is shown and described a preferred embodiment of this invention, simply by way of illustration of one of the best modes suited for to carry out the invention. As it will be realized by those skilled in the art, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWING

The accompanying drawing incorporated in and forming a part of the specification, illustrates an aspect of the present invention, and together with the description serves to explain the principles of the invention. In the drawings:

FIG. 1 illustrates an end fitting for a piping system in accordance with the present invention.

### DETAILED DESCRIPTION OF A PREFERRED EMBODIMENT

As will be appreciated by those skilled in the art, the end fitting piping system of the present invention is suitably adapted for a piping connection suitably incorporating national pipe thread forms to be used as a temporary fitting prior to assembling a permanent piping connection. As is known in the art, the typical range of American standard taper pipe thread sizes is from 1/16 to 4 inches in their approximate increments of 1/16, ⅛, 1/4, and ½ . The skilled artisan will appreciate that the present invention is not limited to piping connections utilizing taper pipe thread sizes of aforementioned sizes and is suitably adaptable to other sizes. It will be also recognised by those skilled in the art that the end fitting of the present invention is not limited to a temporary fitting connection and is suitably adopted to be used as a permanent fitting connection.

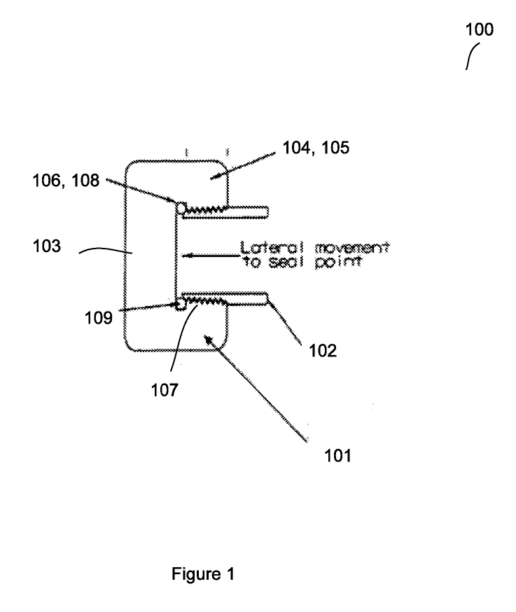

Referring now to FIG. 1 there is shown an end fitting 100 for a piping system in accordance with the present invention. The end fitting 100 includes a sealing body 101 suitably adopted to receive a pipe member 102, which includes an externally threaded portion 107. The sealing body 101 suitably includes an end cap portion 103, and a hollow portion 104. As will be recognized by a skilled artisan, the end cap portion 103 overlaps, at least patially, the hollow portion 104. The hollow portion 104 of the sealing body 101 includes an internally threaded section 105 and a threadless section 106. The threads in the internally threaded section 105 of the hollow portion 104 of the sealing body 101 are tapered oppositely to the threads in the externally threaded portion 107 of the pipe member 102. As will be recognised by those skilled in the art, the length of the internally threaded section 105 of the hollow portion 104 of the sealing body 101 is, preferably, substantially less than the length of the externally threaded portion 107 of the pipe member 102. The threadless section of the hollow portion 104 of the sealing body 101, preferably, further includes an annular groove 108 located adjacent to the internally threaded section 105. A seal retainer 109 is placed in the annular groove 108, the diameter of the annular groove 108 being to some extent smaller than the diameter of the seal retainer 109. A skilled artisan will appreciate that the cross section of the seal retainer 109 is one of round, square, and rectangular. A skilled artisan will appreciate that the seal retainer 109 is advantageously made of suitable resilient material known in the art.

As will be recognized by a skilled artisan, the internally threaded section 105 of the hollow portion 104 of the sealing body 101 is suitably adapted to American standard taper pipe thread sizes. Typically, the range of American standard taper pipe thread sizes is from 1/16 to 4 inches in their approximate increments of 1/16, ⅛, ¼, and ½.

The hollow portion 104 of the sealing body 101 is adapted to receive the externally threaded portion 107 of the pipe member 102. As will be recognized by those skilled in the art, the internally threaded section 105 of the hollow portion 104 of the sealing body 101 is advantageously adapted to engage an externally threaded portion 107 of the pipe member 102. The seal retainer 109 is adapted to come in contact with a distal part of the externally threaded portion 107 of the pipe member 102 prior to the internally threaded section 105 engaging an externally threaded portion 107 of the pipe member 102. A skilled artisan will appreciate, that the sealing body 101 and the pipe member 102 are then suitably hand tightened up.

As will be recognized by those skilled in the art, the end fitting for a piping system requires no tools for tightening. The end fitting of the invention advantageously does not require the use of plumber putty, Teflon tape, or other sealing agents for assembling.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. An end fitting for a piping system, comprising:
a sealing body comprising
a hollow portion including at least one seal retainer; and
an end cap portion, the end cap portion at least partially overlapping the hollow portion; and
wherein the hollow portion of the sealing body includes an internally threaded section and a threadless section,
wherein the hollow portion of the sealing body is adapted to receive an externally threaded portion of a pipe member, the threads in the internally threaded section of the hollow portion of the sealing body being tapered oppositely to the threads in an externally threaded portion of a pipe member, an externally threaded portion having a distal part;
wherein the internally threaded section of the hollow portion of the sealing body is adapted to engage an externally threaded portion of a pipe member; and
wherein the at least one seal retainer is adapted to come in contact with the distal part of an externally threaded portion of a pipe member prior to the internally threaded section of the hollow portion of the sealing body engaging an externally threaded portion of a pipe member.

2. The end fitting for a piping system of claim 1, wherein the threadless section of the hollow portion of the sealing body further includes at least one annular groove located adjacent to the internally threaded section of the hollow portion of the sealing body, the at least one seal retainer being placed in the at least one annular groove.

3. The end fitting for a piping system of claim 2, wherein the diameter of the at least one annular groove is to some extent smaller than the diameter of the at least one seal retainer.

4. The end fitting for a piping system of claim 3, wherein the cross section of the at least one seal retainer is one of round, square, and rectangular.

5. The end fitting for a piping system of claim 1, wherein the internally threaded section of the hollow portion of the sealing body is substantially shorter than an externally threaded portion of a pipe member.

6. The end fitting for a piping system of claim 1, wherein the internally threaded section of the hollow portion of the sealing body is adapted to American standard taper pipe thread sizes.

7. The end fitting for a piping system of claim 6, wherein the range of American standard taper pipe thread sizes is from 1/16 to 4 inches in their approximate increments of 1/16, 1/8, 1/4, and ½.

8. The end fitting for a piping system of claim 1, wherein the sealing body and the pipe member are hand tightened up.

9. The end fitting for a piping system of claim 1, wherein the at least one seal retainer is made of a resilient material.
